(19) United States
(12) Patent Application Publication
(10) Pub. No.: US 2008/0076396 A1
(43) Pub. Date: Mar. 27, 2008

(54) Communication Device and Terminal Presence Confirmation Method

(75) Inventors: Toshihiro Sotomaru, Saitama (JP); Hidemi Usuba, Saitama (JP)

Correspondence Address: FOLEY AND LARDNER LLP;SUITE 500, 3000 K STREET NW, WASHINGTON, DC, 20007, US

(73) Assignee: PIONEER CORPORATION, MEGURO-KU, TOKYO (JP)

(21) Appl. No.: 11/665,750

(22) PCT Filed: Oct. 3, 2005
(86) PCT No.: PCT/JP05/18297

§ 371 Date: Nov. 7, 2007

(30) Foreign Application Priority Data
Oct. 20, 2004 (JP) 2004-305854

(51) Int. Cl. H04Q 7/22

(52) U.S. Cl. 455/414.1

(57) ABSTRACT

A communication apparatus according to the present invention serves as a manager apparatus which manages a communication network, and includes a database 13 that stores a device list of a terminal constituting the communication network; a network management unit 11 that checks the presence of a terminal registered in the device list by a polling processing, and updates the device list based on a result of the check; and a packet analyzer 12 that analyzes whether or not a received signal is a response to a presence check message sent in the polling processing, for example. In the communication apparatus, when a new request for updating the device list occurs during performing an active processing for the device list update, the network management unit 11 identifies a result of the active update processing as a result of processing the new request, without performing a new processing for the device list update in response to the new request.

### TECHNICAL FIELD

The present invention relates to a communication apparatus which performs communication for checking the presence of a terminal constituting a network, and a method of checking the terminal presence using the communication apparatus.

### BACKGROUND ART

Conventionally, in a general communication network consisting of a plurality of communication apparatuses, a particular communication apparatus which manages the network performs communication for a presence check with respect to each of the other communication apparatuses, regularly or at a given time. In this case, the particular communication apparatus determines that the communication apparatus responding to the communication for the presence check is still in the network and the communication apparatus not responding is out of the network, and thereby updates a database equipped in itself, for example.

For example, a system called “Wireless 1394” is taken as one example of an interface for the network which performs communication for the presence check described above (see Nonpatent literature 1 below). The Wireless 1394 system is an interface for a home network modified as an unwired system from the IEEE 1394 system which has already started to spread mainly for personal computer and video equipment, and inherits the characteristics of the IEEE 1394 system, such as high-speed performance, real-time performance, and operability.

Here, a method in which the particular communication apparatus checks the presence of each communication apparatus (terminal) constituting the network, will be explained briefly. In the Wireless 1394 system, the ID of each terminal is stored in a database called “Vid (Virtual ID) table” to manage terminals in the network. Management and update of the “Vid table” is performed by a wireless bus manager (WBM) serving as the particular communication apparatus described above.

When a request for updating the “Vid table” database is made by an application, the WBM refers to the database for terminals in entry to the network, sends a control signal sequentially to all terminals which currently appear to be in the network, and waits for a response from each of the terminals (polling processing). Then, the WBM updates the database based on the response result to inform each of the terminals constituting the network of the latest content of the database. In this update processing, the terminal not responding is determined to be out of service of the communication (determined to be out of the network), and the corresponding terminal is deleted from the database. When the request for updating the database occurs in succession, the processing described above is performed repeatedly.

Nonpatent literature 1: 1394TA Working Draft 2003011, Protocol Adaptation Layer (PAL) for IEEE 1394 over IEEE 802.11e, Revision 0.71, Sep. 10, 2003

### DISCLOSURE OF INVENTION

### Problem to be Solved by the Invention

In the conventional communication system described above, however, since the particular communication apparatus (WBM) performs the presence check (polling) of each communication apparatus (terminal) constituting the network on all terminals registered in the database equipped in itself, there has been a problem that a successive occurrence of the request for updating the database would prevent the original duty of data communication, such as video communication. In other words, there has been a problem that the successive occurrence of polling would occupy the wireless resource more than necessary.

The problems to be solved by the present invention include, as one example, a possibility that the successive occurrence of the request for updating the database would result in ineffective use of the wireless resource due to a frequent occurrence of the polling processing in the case where the presence check of each terminal constituting the network is performed.

### Means for Solving Problem

To solve the problems and achieve the object, a communication apparatus according to the invention as set forth in claim 1 serves as a particular apparatus managing a communication network to perform a presence check of a terminal constituting the communication network, and includes a database unit that stores a device list for managing the terminal constituting the communication network; a network management unit that checks a presence of the terminal registered in the device list by a polling processing, and updates the device list based on a result of the check; and a received-signal analyzing unit that analyzes whether a received signal is a response signal to a presence check message sent in the polling processing, wherein when a new request for updating the device list occurs during an active processing for updating the device list, the network management unit identifies a result of the active processing for updating the device list as a result of processing the new request for updating the device list, without performing a new processing for updating the device list in response to the new request for updating the device list.

The invention as set forth in claim 4 is a method of checking a terminal presence in which a communication apparatus managing a communication network checks, based on a device list which manages a terminal constituting the communication network, a presence of the terminal registered in the device list. The method includes the steps of performing a polling processing for checking the presence of the terminal registered in the device list when a request for updating the device list occurs; and updating the device list based on a result of the polling processing, wherein when a new request for updating the device list occurs during performing each of the steps, a result of the active step of updating the device list is identified as a result of the processing for updating the device list in response to the new request, without performing the polling processing in response to the new request.

### BRIEF DESCRIPTION OF DRAWINGS

FIG. 1 illustrates an example of a configuration of a wireless communication network including a communication apparatus according to the present invention;

FIG. 2 is a diagram of a structure of a manager apparatus according to a first embodiment;

FIG. 3 is a flowchart of a processing for checking a terminal presence according to the first embodiment;

FIG. 4 is a diagram of a structure of a manager apparatus according to a second embodiment;

FIG. 5 is a flowchart of a processing for checking a terminal presence according to the second embodiment; and

FIG. 6 is a flowchart of a processing for checking a terminal presence according to a third embodiment.

### EXPLANATIONS OF LETTERS OR NUMERALS

1 Manager apparatus
2-1, 2-2, . . . , 2-N Client apparatuses (terminals)
11, 11a Network management unit
12 Packet analyzer
13, 13a Database
14 Packet transceiver
15a Timer

### BEST MODE(S) FOR CARRYING OUT THE INVENTION

Exemplary embodiments of a communication apparatus and a method of checking the presence of a terminal according to the present invention will be explained in detail below with reference to the accompanying drawings. It should be noted that the present invention is not limited to the embodiments.

### First embodiment

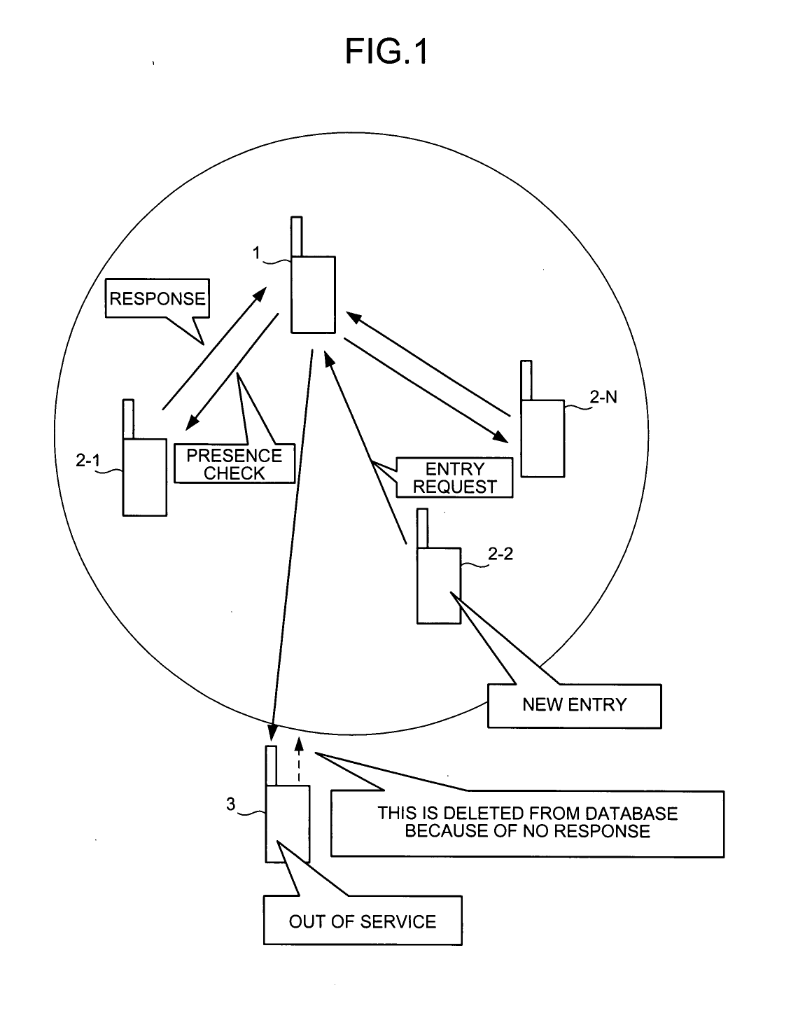

FIG. 1 illustrates an example of a configuration of a wireless communication network including a communication apparatus according to the present invention. The wireless communication network includes a manager apparatus 1 as a particular communication apparatus which manages the network, and client apparatuses (terminals) 2-1, 2-2, 2-N as communication apparatuses, constituting the network. The numeral 3 in FIG. 1 denotes, for example, a terminal which is out of service in the communication as a communication apparatus out of the network. The processing according to the present embodiment is applicable to any systems which have necessity for performing a presence check of terminals constituting the network, such as Ultra Wide Band (UWB), wireless LAN, and Bluetooth systems. In the following description, though the present embodiment uses a wireless communication network as one example, the invention is not limited thereto and is also applicable to a cable communication network. The method of checking the terminal presence according to the present invention can be implemented in any communication apparatuses constituting the network. In other words, any one of the communication apparatuses constituting the network dynamically operates as the manager apparatus.

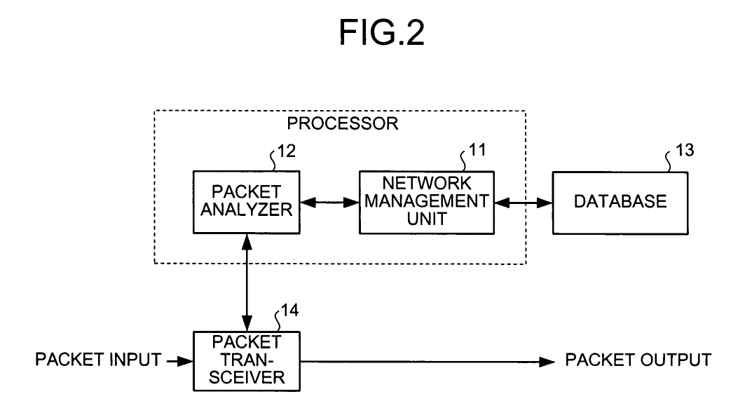

FIG. 2 is a diagram of a structure of the manager apparatus 1 according to the first embodiment. The manager apparatus 1 includes a network management unit 11 that implements the method of checking the terminal presence in the present embodiment; a packet analyzer 12 that analyzes a received packet to inform the network management unit 11 of whether or not the received packet relates to a response signal to a presence check message (analysis result) in a polling processing; a database 13 that stores a device list for managing the terminals constituting the network; and a packet transceiver 14 which transmits and receives the packet. Though the present embodiment assumes a packet communication, the presence check of the terminals constituting the network may be performed in other communication except for the packet communication.

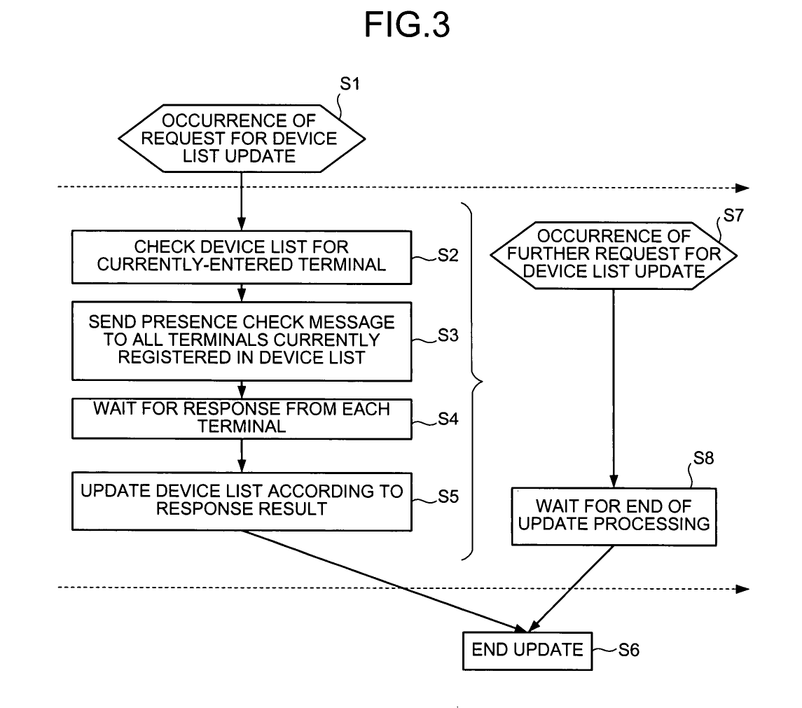

The method of checking the terminal presence according to the present embodiment will be explained specifically. FIG. 3 is a flowchart of a processing for checking the terminal presence according to the first embodiment. Here, a case where a terminal 2-2 newly enters the network will be explained as an example.

For example, when a request for updating the device list occurs due to a new entry of the terminal 2-2 to the network (step S1), the network management unit 11 of the manager apparatus 1 reads out the terminals which are currently in entry to the network from the device list stored in the database 13 (step S2). Except for the case where the new terminal enters the network, the request for device list update may be made from any terminals (including the manager apparatus 1) which detect, for example, a change in the network composition (a withdrawal of a specific terminal from the network and the like).

Next, the network management unit 11 of the manager apparatus 1 performs the polling processing in which the network management unit 11 sends the presence check message (packet) sequentially to all of the terminals registered in the device list (step S3) and waits for the response from each of the terminals (step S4) by way of the packet analyzer 12 and the packet transceiver 14. Then, the packet analyzer 12 analyzes the response signal received by way of the packet transceiver 14, and the network management unit 11 updates the device list in the database 13 based on the response result (step S5). Then, the manager apparatus 1 informs each terminal constituting the network of the latest content of the device list, and ends the processing for checking the terminal presence (step S6). In the update processing described above, for example, when no response is returned from a certain terminal (time-out), the corresponding terminal is determined to have withdrawn from the network (determined to be out of service in the communication, for example), and deleted from the device list in the database 13. Here, though the terminal without response is configured to be deleted from the device list as one example, the present invention is not limited thereto, and alternatively the database may be prepared with a flag indicating the current status and may update the flag depending on an entry and a withdrawal.

In the present embodiment, when a new request for the device list update (assuming this request to be a second request for the device list update) occurs while performing the processing of the steps S1 to S6 associated with the request for the device list update (assuming this request to be a first request for the device list update) (step S7), the manager apparatus 1 waits for ending the active processing for checking the terminal presence (step S8), and at the same time ends the processing for checking the terminal presence associated with the second request for the device list update (step S9). In other words, when the new request for the device list update occurs during performing the active processing for checking the terminal presence, the result of the currently-active processing for checking the terminal presence is identified as the result of processing the latest request, without performing the new request for checking the terminal presence.

As described above, in the present embodiment, when a new request for the device list update occurs for some reason while the manager apparatus performs the active processing for checking the terminal presence, the result of the currently-active processing for checking the terminal presence is identified as the result of processing the latest request, without performing the new request for checking the terminal presence. This configuration allows reducing the processing, not being the original duty of data communication, for checking the terminal presence in the network, in other words, allows avoiding a repetitive execution of the processing for checking the terminal presence more than necessary, and thereby the original duty of data communication (video communication and the like) is not prevented, resulting in an effective use of the communication resource (cutting the waste occupancy of the wireless resource).

### Second Embodiment

A second embodiment will specify a processing of the manager apparatus 1, for the case where a new request for the device list update occurs during a specific period after the end of the processing for checking the terminal presence in the first embodiment. It should be noted that the network composition is the same as that of FIG. 1 in the first embodiment.

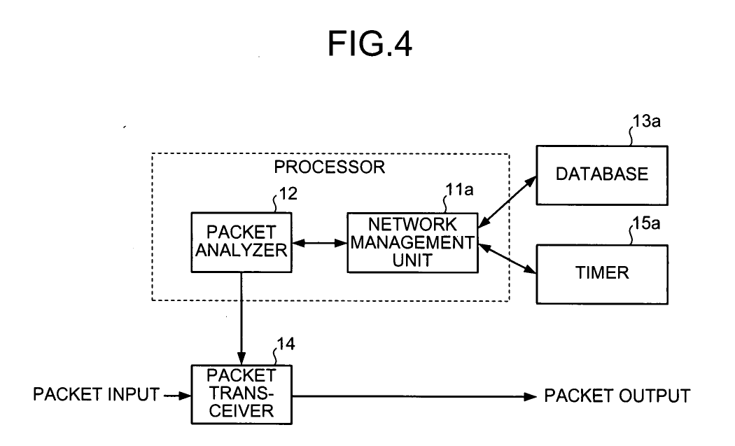

FIG. 4 is a diagram of a structure of a manager apparatus 1 according to the second embodiment. The manager apparatus 1 includes a timer 15a; a database 13a that stores, in addition to the device list described above, a time (output value of the timer 15a) when the device list is lastly updated; and a network management unit 11a that performs, in addition to the function of the network management unit 11 of the first embodiment, a predetermined processing which will be described later, during the specific period. The same components of the manager apparatus 1 as those in the first embodiment are provided with the same numerals and the explanation thereof is omitted here.

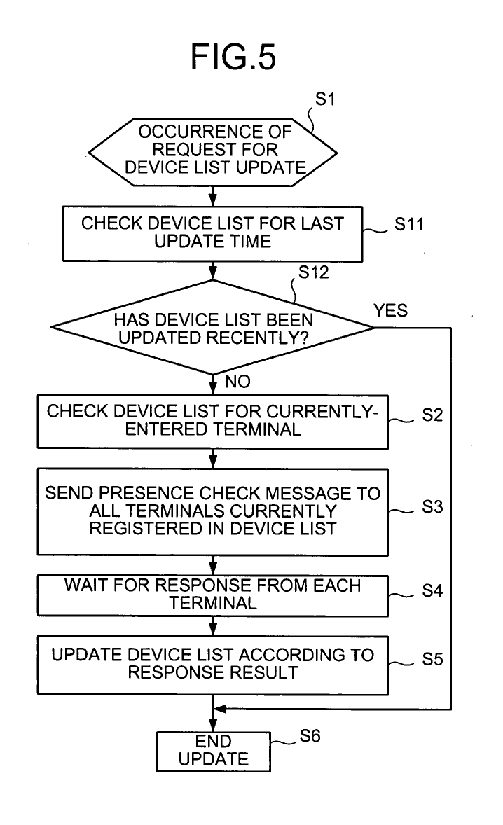

Next, a method of checking the terminal presence according to the present embodiment will be explained specifically. FIG. 5 is a flowchart of a processing for checking the terminal presence according to the second embodiment. Here, the processing different from the first embodiment will only be explained.

When a new request for the device list update occurs (step S1) for example, the network management unit 11a of the manager apparatus 1 reads out the current time from the timer 15a and the time when the device list is lastly updated from the database 13a, and calculates the difference therebetween (step S11).

When the time difference is not more than a predetermined threshold (corresponding to the specific period described above) (“Yes” at step S12), the network management unit 11a determines the current device list to be recently-updated device list (no change is present in the network composition), and immediately ends the processing without performing a new processing for checking the terminal presence (step S6). On the other hand, when the time difference is more than the threshold (“No” at step S12), the network management unit 11a determines the current device list not to be recently-updated device list (change is present in the network composition), and performs the processing of the steps S2 to S6.

As described above, in the present embodiment, when a new request for the device list update occurs during the specific period after the processing for checking the terminal presence ends, no new processing for checking the terminal presence is performed in response to the new update request. This configuration allows further reducing the processing for checking the terminal presence, resulting in more effective use of the communication resource.

### Third Embodiment

In a third embodiment, the polling processing is more reduced than required in the first embodiment in a different way from the second embodiment. Here, a case where the terminal presence can be checked in a way other than the polling processing will be specified. The network composition is the same as that of FIG. 1 in the first embodiment. Though the structure of the manager apparatus 1 is basically the same as that in the second embodiment, a database 13a according to the third embodiment is based on the premise that a communication history of each terminal constituting the network is stored therein.

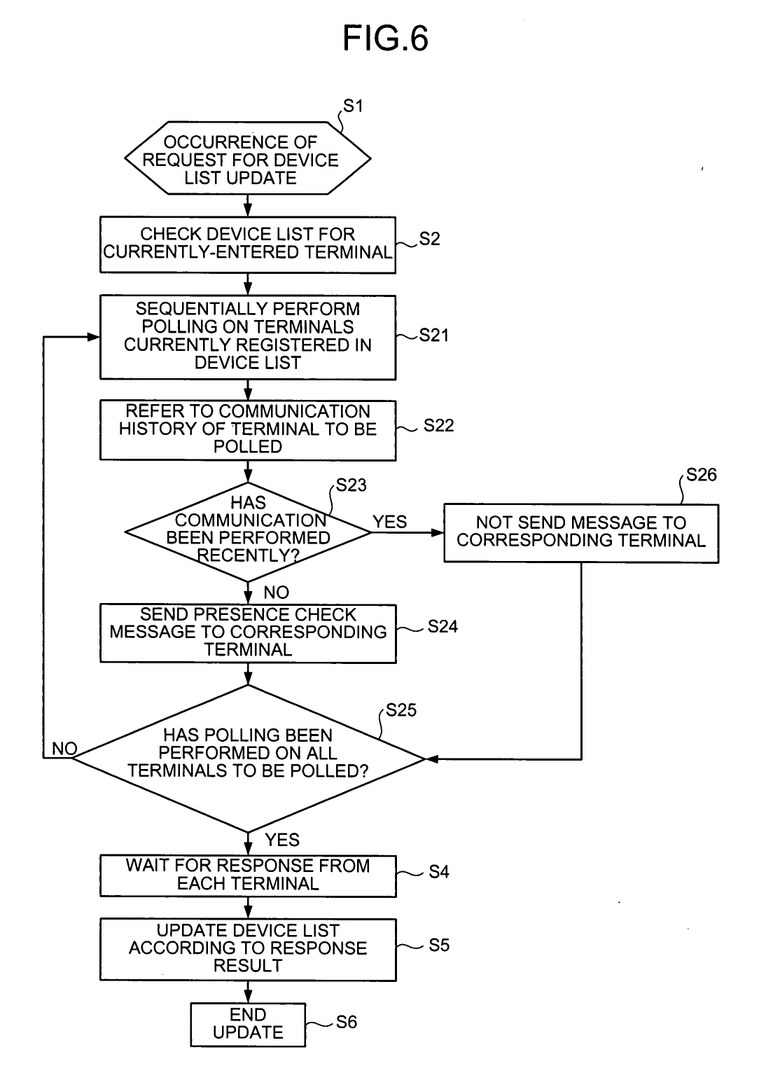

Next, a method of checking the terminal presence according to the present embodiment will be explained specifically. FIG. 6 is a flowchart of a processing for checking the terminal presence according to the third embodiment. Here, the processing different from the first embodiment will only be explained.

For example, after reading out the currently-entered terminal from the device list stored in the database 13a (step S2), the network management unit 11a starts the polling processing sequentially on the readout terminals (step S21). Then, the network management unit 11a refers to the communication history of the corresponding terminal to be polled which is stored in the database 13a (step S22), and determines whether or not any communication is performed by checking a predetermined time back. When no communication is performed during the predetermined time (“No” at step S23), the network management unit 11a determines that there is a possibility of having a change in the network composition, and sends a presence check message to the corresponding terminal (step S24). On the other hand, when communication is performed during the predetermined time (“Yes” at step S23) as a result of determination on whether or not any communication is performed by checking the predetermined time back, the network management unit 11a determines that there is no change in the network composition (no terminal has withdrawn from the network), and does not send the presence check message to the corresponding terminal (step S26).

The network management unit 11a sequentially performs the processing of the steps S21 to S26 on the terminals to be polled (“No” at step S25), and performs the processing of the steps S4 to S6 at a stage where the processing of the steps S21 to S26 is completed with respect to all of the terminals to be polled (“Yes” at step S25).

As described above, when communication is performed as a result of checking a predetermined time back based on the communication history, which is stored in the database, of each terminal constituting the network for example, the polling processing is not performed on the corresponding terminal in the present embodiment. This configuration allows further reducing the polling processing, resulting in more effective use of the communication resource.

1. A communication apparatus which serves as a particular apparatus managing a communication network, and performs a presence check of a terminal constituting the communication network, the communication apparatus comprising:
a database unit that stores a device list for managing the terminal constituting the communication network;
a network management unit that checks a presence of the terminal registered in the device list by a polling processing, and updates the device list based on a result of the check; and
a received-signal analyzing unit that analyzes whether a received signal is a response signal to a presence check message sent in the polling processing, wherein
when a new request for updating the device list occurs during an active processing for updating the device list, the network management unit identifies a result of the active processing for updating the device list as a result of processing the new request for updating the device list, without performing a new processing for updating the device list in response to the new request for updating the device list.

2. The communication apparatus according to claim 1, wherein
the database unit further stores a finish time of the update processing, and
the network management unit does not perform a new processing for updating the device list in response to a new request for updating the device list when the new request for updating the device list occurs in a predetermined period after the finish time.

3. The communication apparatus according to claim 1, wherein
the database unit further stores a communication history of the terminal to be polled, and
the network management unit refers to the communication history of the terminal to be polled, checks whether communication has been performed with the terminal by checking a predetermined time back, sends a presence check message to the terminal if the terminal has no communication during the predetermined time, and sends no presence check message to the terminal if the terminal has communication.

4. A method of checking a terminal presence, in which a communication apparatus managing a communication network checks, based on a device list which manages a terminal constituting the communication network, a presence of the terminal registered in the device list, the method comprising the steps of:
performing a polling processing for checking the presence of the terminal registered in the device list when a request for updating the device list occurs; and
updating the device list based on a result of the polling processing, wherein
when a new request for updating the device list occurs during performing each of the steps, a result of the active step of updating the device list is identified as a result of the processing for updating the device list in response to the new request, without performing the polling processing in response to the new request.

5. The method of checking a terminal presence according to claim 4, wherein when a new request for updating the device list occurs in a predetermined period after a finish time of the step of updating the device list, the step of performing a new polling processing is not performed in response to the new request.

6. The method of checking a terminal presence according to claim 4, wherein the step of the polling processing includes referring to a communication history of the terminal to be polled, checking whether communication has been performed with the terminal by checking a predetermined time back, sending a presence check message to the terminal if the terminal has no communication during the predetermined time, and sending no presence check message to the terminal if the terminal has communication.
